(19) United States
(12) Patent Application Publication
(10) Pub. No.: US 2011/0040977 A1
(43) Pub. Date: Feb. 17, 2011

(54) SPONGE AND HASH FUNCTIONS USING A RUBIK'S CUBE PUZZLE PROCESS

(75) Inventors: Augustin J. FARRUGIA, Cupertino, CA (US); Benoit Chevallier-Mames, Paris (FR); Mathieu Ciet, Paris (FR)

Correspondence Address: APPLE c/o MORRISON & FOERSTER LLP PALO ALTO, 755 PAGE MILL ROAD, PALO ALTO, CA, 94304-1018, US

(73) Assignee: Apple Inc., Cupertino, CA (US)

(21) Appl. No.: 12/539,530

(22) Filed: Aug. 11, 2009

(51) Int. Cl. H04L 9/32; H04L 9/28

(52) U.S. Cl. 713/181

(57) ABSTRACT

The present method is directed, in the computer data security field, to cryptographic sponge and hash function processes which are embodied in a computer system and are typically keyless, but highly secure. The processes are based on the type of randomness exhibited by manipulation of the well known three dimensional Rubik's cube puzzle. Computation of the hash or sponge value (digest) is the result of executing in a model (such as computer code or logic circuitry) an algorithm modeling such a puzzle using the message as an input to the cube puzzle algorithm, then executing the cube puzzle algorithm. A state of the modeled cube puzzle (the final cube puzzle arrangement) after execution gives the sponge or hash digest value of the message.

### FIELD OF THE INVENTION

This invention relates to computers, computer data security, and sponge functions and hash functions (hashing).

### BACKGROUND

Hash functions are well known in the field of data security. The principle is to take data (a digital message, digital signature, etc.) and use it as an entry to a hash function resulting in an output called a “digest” of predetermined length which is intended to uniquely identify (“fingerprint”) the message. A secure (cryptographic) hash is such that any alteration in the message results in a different digest, even though the digest is much shorter than the message. Such hash functions are “collision-resistant” and “one-way.”

In the field of hash functions, there is a more general category called “sponge functions”. They are hash-like functions, but while hash functions only output a fixed size digest, sponge functions are able to produce a result (digest) of any size, with a fixed level of security. In this sense a sponge function is more general than a hash function.

Cryptography and data security deal with digital signatures, encryption, document authentication, and sponge functions and hashing. In all of these fields, there is a set of basic tools/functions which are widely used, for instance hash functions. Several properties are required for the use of hash and sponge functions in cryptographic applications: preimage resistance, second preimage resistance and collision resistance.

In the recent years, much energy has been expended finding new hash functions, since collisions (weaknesses or successful attacks) have been found in the widely used SHA-1 standard hash.

### SUMMARY

Disclosed here are new types of cryptographic (secure) sponge and hash functions or processes. The goal is a highly modular sponge or hash function which is also computationally efficient (fast). The present sponge and hash functions conventionally can be used for document integrity for exchanges and signatures. They can be also used as a derivation function or as a HMAC (hash message authentication code) by adding a key conventionally (as for instance in the well known HMAC-SHA1) and the terms “sponge” and “hash” as used herein are intended to encompass all these uses, both keyed and non-keyed.

A hash or sponge function is a deterministic procedure that accepts an arbitrary input value, and returns a sponge or hash value. The input value is called the message, and the resulting output value is called the digest. The message is authenticated by comparing the computed digest to an expected digest associated with the message.

The present sponge and hash processes are based on the concept and rules of physical Rubik's cube puzzles. The Rubik's cube is a well known three dimensional mechanical puzzle invented by Erno Rubik. It is a cube (so having 6 faces). The sides of the cube are colored. There are 26 miniature cubes that make up the main cube, called cubies or cubelets. A pivot mechanism allows each face of the cube to turn independently to mix up the colors. Each face has 9 sub-faces, arranged 3×3 in terms of the cubies. The standard Rubik's cube has 4.33×10¹⁹ permutations, so the puzzle is capable of achieving a high degree of randomness. Solving the conventional puzzle requires arranging it so each cube face is all one color.

Variants are also known having cubies arranged 2×2×2, 4×4×4, 5×5×5, 6×6×6, and 7×7×7. There are other cuboid variants which are 2×3×4, 3×3×5, and 2×2×4.

There are also non-rectangular variations which are octahedrons and dodecahedrons. It is also well known to model these puzzles in computer software including very large puzzles such as 100×100×100 cubies or larger, or 4 or 5 dimensional versions which have no physical counterpart.

No actual (physical) puzzle is manipulated or even displayed on a computer screen in accordance with the invention and there is no player. Further, there is no requirement to solve the cube. Instead a “notional” puzzle (in terms only of movement of the cubies) is modeled logically, without any player. The endpoint of the process is when the notional puzzle has achieved some degree of randomness. But in accordance with the present sponge and hash functions, there is no introduction of randomness from a user (player) since the way the puzzle (which is notional) is manipulated is uniquely determined by the input (the message to be hashed or sponged) in one embodiment. This means the sponge and hash functions disclosed here are completely deterministic. The notional puzzle is any one of the above described puzzles or variants thereof; it need not conform to any such actual puzzle in terms of rules (such as cubie or cube arrangement or having any actual corresponding physical puzzle).

The present approach is based on the observation that actual Rubik's cube puzzles exhibit a high degree of chaos in the way the puzzle is arranged after a number of moves (unless the player is trying to solve the puzzle.). The present goal is to use the principles of such puzzles to compute a hash or sponge function since such a chaotic (randomness) characteristic is typically what is required to provide a secure sponge or hash function. In this sense secure means strongly one way, meaning that given a message it is easy to compute the digest, but it is very difficult to find a message that returns a given digest.

Since the Rubik's cube is well known and exists in several variants as explained above, programming details of the present puzzle modeling algorithm (which models such puzzles as a process in accordance with the invention) are given here in embodiments for the classical 3×3×3 Rubik's cube. Writing computer code (or designing equivalent logic circuitry) for puzzle variants as described above or other variants would be routine to one skilled in the art in light of this disclosure.

Moreover the present sponge and hash functions are computed very rapidly in computer software (or hardware—dedicated logic circuitry). For instance, a hash “checksum” as used when transferring data requires fast determination of the digest. This hash function is especially useful when transferring large amounts of data.

Note that terms such as “cube,” “cubie,” “color,” “face,” “cell,” “rotation,” “line,” “column,” “axis,” and “puzzle” used here in connection with the present invention do not refer to any physical object or puzzle or any actual depiction of same even on a computer or game display, but instead to values, identifiers, or variables used in computer code or logic to compute a sponge or hash function or equivalent, and are used only for convenience of understanding herein as referring conceptually to analogous aspects of the above described Rubik's cube puzzle.

While two detailed examples of the present method and associated apparatus are given here, these are not limiting. The present method and apparatus also include algorithms based on variants of the Rubik's cube puzzle both as described here and otherwise known, and further variants apparent in light of this disclosure. All these variants are referred to here generically as “cube puzzles”, even though some are not based on cubes, as explained above.

Further, the terms “sponge” or “sponge function” as used here may respectively refer also to “hash” and “hash function”, a hash function being a type of sponge function as explained above.

### BRIEF DESCRIPTION OF THE FIGURES

FIG. 1 shows a set of variables and parameters.

FIG. 2 shows relevant portions of a computing device for carrying out the present method.

FIG. 3 shows additional detail of the FIG. 2 computing device.

### DETAILED DESCRIPTION

The sponge and hash functions described in the following examples are based on the Rubik's cube puzzle, in the sense that one models a 6-face cube (but this is not limiting, as explained above). With manipulation of the puzzle, one modifies the state of the cube. Based on this, one constructs a sponge function. Sponge functions as explained above are a more general type of hash function where the output length (the length of the digest) can be chosen at the time of computation. Hence a hash function is a type of sponge function.

In a sponge function as well as in a hash function, the entry is called a message. For the present method, consider two possibilities which are embodied in the two following examples: (1) the message is partitioned into blocks, and processed block per block, or (2) the message is used once for all as the seed for a pseudo random number generator (PRNG), and then the process of Rubik's cube manipulation is applied.

More precisely, consider a (notional) Rubik's cube puzzle of 6 faces (one could consider generalizations with more than 6 faces), where each face is a square of (size*size) cells. Each cell (which is depicted by a color in the physical puzzle) is a byte, a bit, a 16-bit word or a 32-bit word, etc. or more generally, an x-bit word (where x is the bitsize of the word). Then, in the sponge function, by keeping the analogy with the physical puzzle there are more than six colors. In fact, each word codes for a color, so there are 2^{x} colors, where x is the bitsize of the words.

Once the notional Rubik's (or other) cube puzzle is in a given position (state), one may operate on it (that is, manipulate it) by the classical Rubik's cube rotation, i.e. moving one or more lines or columns of cubies in whatever axis is selected (rotation around a given axis). The manipulation can be applied on all the (notional) cubie columns or lines, in whatever axis, and with a certain rotation length depending on the number of faces (either 1 or 2 or 3 rotations in the case of a standard Rubik's cube).

In the following example 1, the (notional) Rubik's cube is initialized with a given initial state S0. Initially, the message is partitioned into a certain number of blocks. If the message length is not a multiple of the length of a block, a certain amount of padding data is applied, as classically done in cryptography. Then the first message block is introduced (see below). Then, a set of rotations is applied (the number and the definition of such rotations are given later). The second message block can be introduced in the same way as the first one. A new set of rotation is performed and so on, until the full message (i.e., all of the message blocks) has been loaded.

For example, this message introduction can be done by logical XORing (exclusive OR operation) some words of the Rubik's cube initial state (which are chosen arbitrarily) with words of the message block. Of course, there are many possibilities for this introduction. One may use a non-linear introduction of the message block, to avoid certain cryptanalytic attacks. Then, based on the message block value and/or the value of the (notional) Rubik's cube state, a particular rotation is chosen and applied to the notional cube (that is by specifying a line or column, an axis, and a rotation length). There may be more than one rotation that is chosen and applied for each message block for better security.

It may be necessary conventionally to add padding to the initial message so as to obtain a given input length having an integer number of blocks, in the same way as for well-known hash functions.

The algorithm of example 1 can be summarized as follows expressed logically and in the following pseudo code form. Function InitialiseRubikCube is for initialization of the Rubik's cube state which is represented here as a data array denoted RubikCubeState. RubikCubeState is an array (e.g., table) of data words, each word being one bit, one byte, one 16-bit word, etc. Function IntroduceMessageBlock performs introduction of the message into the Rubik's cube state. Functions ChooseFace, ChooseAxe, ChooseColumnLine, ChooseRotation are respectively for choosing face, axis, column or line, rotation number to manipulate the Rubik's cube state. Finally, Function ApplyRotation applies the modification on the Rubik's cube state. The following shows example 1 in pseudo code form where this pseudo code is conventionally structurally similar to actual (executable) code such as in the C computer language but less detailed:

```
/* Initialize with initial value S0 */
InitialiseRubikCube(RubikCubeState);
/* For each block of the message */
for (i = 0; i < BlockMessageNumber; i++)
{
    /* Introduce message block into the state */
    IntroduceMessageBlock(RubikCubeState, Message[i]);
    /* Rotate */
    for (j = 0; j < kSEC_PARAMETER; j++)
    {
        // Choose a random rotation
        // Which face
        Face = ChooseFace(RubikCubeState, Message[i])
        % NUMBER_OF_FACES;
        // Axis: either horizontally or vertically
        Axe = ChooseAxe(RubikCubeState, Message[i]) % 2;
        // Which column/line
        Index = ChooseColumnLine(RubikCubeState, Message[i])
        % size;
        // Which rotation number
        Rotation = 1 + (ChooseRotation(RubikCubeState, Message[i]) %
NUMBER_OF_FACES/2));
        // Apply the rotation
        ApplyRotation(RubikCubeState, Face, Axe, Index, Rotation);
    }
}
/* Blank rounds */
for (j = 0; j < kBLANK_ROUNDS_PARAMETER; j++)
{
    // Choose a random rotation
    // Which face
    Face = ChooseFace(RubikCubeState, NULL)
    % NUMBER_OF_FACES;
    // Axis: either horizontally or vertically
    Axe = ChooseAxe(RubikCubeState, NULL) % 2;
    // Which column/line
    Index = ChooseColumnLine(RubikCubeState, NULL) % size;
    // Which rotation number
    Rotation = 1 + (ChooseRotation(RubikCubeState, NULL) %
(NUMBER_OF_FACES/2));
    // Apply the rotation
    ApplyRotation(RubikCubeState, Face, Axe, Index, Rotation);
}
/* Apply the sponge outputting process */
for (i = 0; i < NumberOfBlocksOfDigest; i++)
{
    // Extract a certain number of bytes of the state
    ExtractAndOutput(RubikCubeState);
    // Choose a random rotation
    // Which face
    Face = ChooseFace(RubikCubeState, NULL)
    % NUMBER_OF_FACES;
    // Axis: either horizontally or vertically
    Axe = ChooseAxe(RubikCubeState), NULL) % 2;
    // Which column/line
    Index = ChooseColumnLine(RubikCubeState, NULL) % size;
    // Which rotation number
    Rotation = 1 + (ChooseRotation(RubikCubeState, NULL) %
(NUMBER_OF_FACES/2));
    // Apply the rotation
    ApplyRotation(RubikCubeState, Face, Axe, Index, Rotation);
}
```

Operators used in this pseudo code are conventional for the C computer language. “++” denotes increment by one. Comments (which are non-executable) are delimited by “/*” and “*/” or indicated by “//”. The operator “%” denotes modulo.

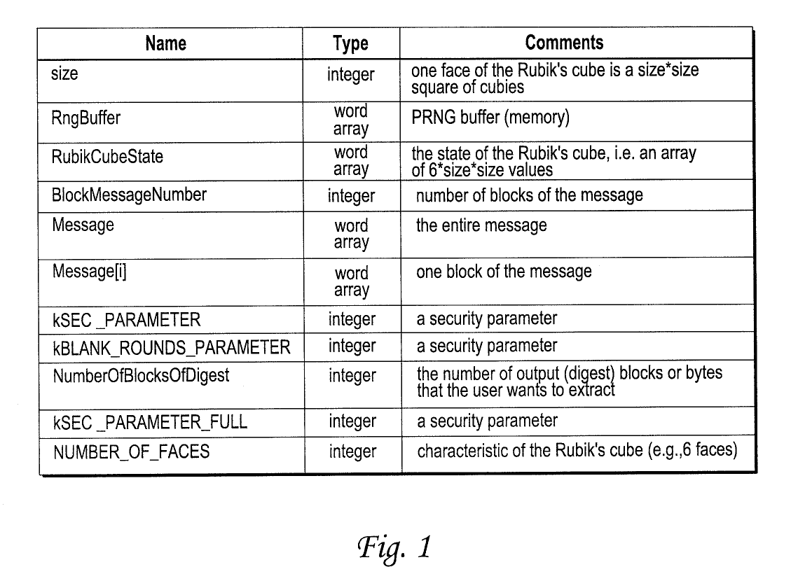

Value kSEC_PARAMETER is a parameter that indicates how many rotations to perform per message block. Value (parameter) kBLANK_ROUNDS_PARAMETER is the number of blank rounds to perform. Blank rounds are well known in sponge function construction. The goal is to modify the Rubik's cube state without any message input (which is why some functions are called with a second parameter to value NULL). Blank rounds can provide better security. FIG. 1 shows, with comments, the variables and parameters with comments of this pseudo code.

At the end of the algorithm, the output is constructed (“Apply the sponge outputting”) block by block (this is the fundamental principle of sponge functions, that the user can ask for how many bytes or blocks of output he wants to extract as the digest). Of course these are not the same as the input blocks of the message. In other words, the output is constructed part-by-part, in a regular iterative process. Note that even in the outputting process, the algorithm performs further rotations, in order to modify the puzzle state. The algorithm of example 1 performs one new rotation per call to ExtractAndOutput but this number may be increased for better security.

The algorithm of example 2 which follows is similar to that of example 1, except that in example 2 the message is not initially partitioned into blocks, and is used only as the seed of a conventional PRNG (pseudo random number generator). Example 2 is summarized as follows. Function InitPRNG performs the initialization of the PRNG with the message as the seed. Function InitialiseRubikCubeWithPRNG is for initialization of the Rubik's cube state with internal calls to PRNG. Functions ChooseFaceWithPRNG, ChooseAxeWithPRNG, ChooseColumnLineWithPRNG, ChooseRotationWithPRNG are respectively for choosing the face, axis, column or line, and rotation number to manipulate the Rubik's cube state, using the PRNG to make the choice. Finally, as before, function ApplyRotation applies the modification on the Rubik's cube state. The following expresses example 2 in pseudo code:

```
/* Initialize the PRNG with message */
InitPRNG(RNGBuffer, Message)
/* Initialize with the PRNG */
/* Rotate */
for (j = 0; j < kSEC_PARAMETER_FULL; j++)
{
    /* Choose a random rotation */
    // Which face
    Face = ChooseFaceWithPRNG(RubikCubeState)
    % NUMBER_OF_FACES;
    // Axis: either horizontally or vertically
    Axe = ChooseAxeWithPRNG(RubikCubeState) % 2;
    // Which column/line
    Index = ChooseColumnLineWithPRNG(RubikCubeState) % size;
    // Which rotation number
    Rotation = 1 + (ChooseRotationWithPRNG(RubikCubeState) %
(NUMBER_OF_FACES/2));
    // Apply the rotation
    ApplyRotation(RubikCubeState, Face, Axe, Index, Rotation);
}
/* Apply the sponge outputting */
for (i = 0; i < NumberOfBlocksOfDigest; i++)
{
    // Extract a certain number of bytes of the state
    ExtractAndOutput(RubikCubeState);
    /* Choose a random rotation */
    // Which face
    Face = ChooseFaceWithPRNG(RubikCubeState)
    % NUMBER_OF_FACES;
    // Axis: either horizontally or vertically
    Axe = ChooseAxeWithPRNG(RubikCubeState) % 2;
    // Which column/line
    Index = ChooseColumnLineWithPRNG(RubikCubeState) % size;
    // Which rotation number
    Rotation = 1 + (ChooseRotationWithPRNG(RubikCubeState) %
(NUMBER_OF_FACES/2));
    // Apply the rotation
    ApplyRotation(RubikCubeState, Face, Axe, Index, Rotation);
}
```

As in example 1, the output (digest) is constructed block by block, and at least one rotation (one in example 2, but possibly more in other embodiments) is performed for each new output block. Note that for example 2, the blank rounds and message rounds are mixed in a single loop. There is in example 2 no security reason to apply blank rounds. Indeed, by the use of a secure PRNG, the adversary can not control at all what happens in the message rounds, and thus, there is no more need of blank rounds as in example 1.

For better security, both in examples 1 or 2, one may substitute different types of rotations. Instead of just manipulating the cubies, as in the physical Rubik's cube puzzle, one can “modify” the values. The following explains this.

The rotation of one step can be formalized as a square with 4 sides (in the case of a conventional 6 faced Rubik's cube), designated A, B, C, D. These sides are modified, in order to obtain a new square of 4 sides, designated A′, B′, C′, D′. For a rotation of more than one step, the process is simply re-applied.

Classical Rubik's cube rotation (as in the physical puzzle) is expressed in this notation as A′=B, B′=C, C′=D, D′=A. But of course, for the sponge function, one could extend this to other formulas. Notably, consider a formula with linear operators (such as XOR-exclusive OR- or ROTATE), as well as a formula with non linear operations (such as +, *, −, or even SBOX as well known in cryptography). Notably, in a variant of examples 1 or 2, consider rotation where the type of rotation is different depending on which cubie is considered.

An example of a more complex rotation is expressed in this notation as: B′=A+B, C′=A+B+C, D′=A+B+C+D, A′=A+D, or B′=ÂB, C′=ÂB̂C, D′=ÂB̂ĈD, A′=ÂD. (Here “̂” is the XOR logical operator.) One could also use polynomials or any kind of function for the pseudo Rubik's rotation functions. One reason for using modified rotation functions is to have a carry propagation process, or more generally, to increase what are called diffusion and confusion in cryptography to enhance security.

Of course, a hash function is readily derived from a sponge function, by forcing the value NumberOfBlocksOfDigest to be a constant.

Note that for implementation or speed issues, one may be interested in limiting the number of possible rotations of the Rubik's cube. Furthermore, to increase the number of possibilities and so the chaotism (randomness) of the function, one may insert, either from time to time or systematically, some movement of the whole Rubik's cube on itself. This means not manipulating a line or column of the cube, but turning the cube on itself around one of its three axes. Such a function, called for instance RotateTheCube(RubikCubeState, Axe, RotationLength), where Axe is the axis of rotation, and RotationLength is the number of steps of the rotation, may increase the security of the sponge function.

Similarly to hash functions, sponge functions can be keyed. This is carried out in the same way as creating a conventional HMAC function from a hash function. Note that there are also constructions of an HMAC directly made from sponge functions.

FIG. 1 shows values and parameters of the above examples, with comments.

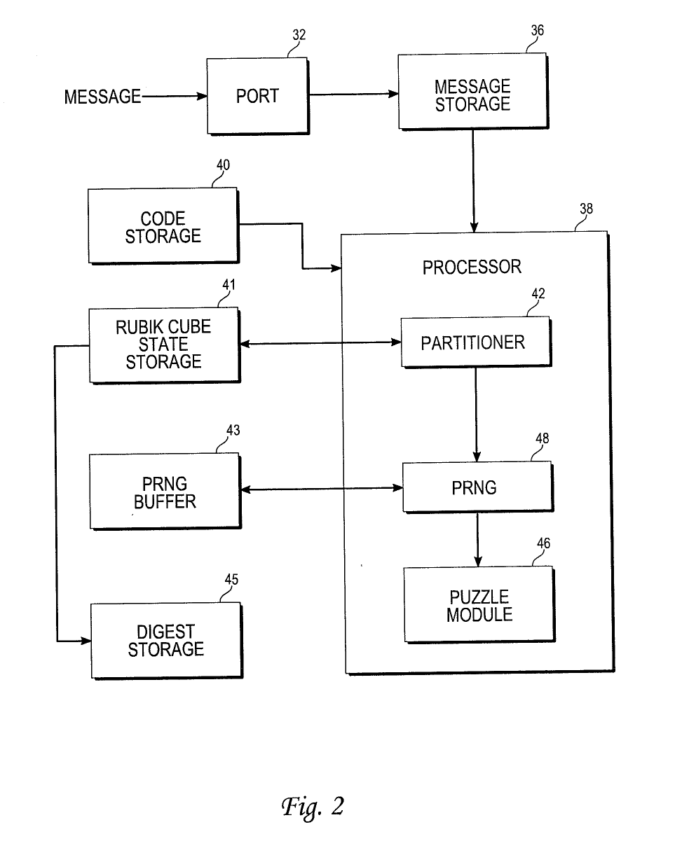

FIG. 2 shows in a block diagram relevant portions of a computing device (system) 30 in accordance with the invention. This is, e.g., a server platform, computer, mobile telephone, Smart Phone, personal digital assistant or similar device, or part of such a device and includes conventional hardware components executing in one embodiment software (computer code) as represented by the above pseudo-code examples. This code may be, e.g., in the C or C++ computer language or its functionality may be expressed in the form of firmware or hardware logic; writing such code or designing such logic would be routine in light of the above pseudo code. Of course the above pseudo code examples are not limiting.

The computer code is conventionally stored in code memory (computer readable storage medium, e.g., ROM) 40 (as object code or source code) associated with conventional processor 38 for execution by processor 38. The incoming message (in digital form) is received at port 32 and stored in computer readable storage medium (memory, e.g., RAM) 36 where it is coupled to processor 38. Processor 38 conventionally partitions the message into suitable sized blocks at partitioning module 42. Other software (code) modules in code memory 40 executed by processor 38 make up the cube puzzle algorithm module 46 and PRNG 48 which carry out the pseudo code functionality set forth above in examples 1 or 2 or variants thereof. The data array of RngBuffer is stored in storage 41 (e.g., RAM) and the PRNG values in PRNG buffer 43 (e.g., RAM).

Also coupled to processor 38 is a storage 45 (e.g., RAM) for the resulting extracted digest. The digest is conventionally extracted from the array in storage 41 or buffer 43 per respectively examples 1 and 2, for instance as n consecutive entries so as to provide a digest of sufficient length. One can perform this extraction in various ways, so as to extract the needed number of bytes for the digest from the final state of the array or buffer. Storage locations 36, 40, 41, 43, 45 may be in one or several conventional physical memory devices (such as semiconductor RAM or ROM or their variants or a hard disk drive).

Electric signals conventionally are carried between the various elements of FIG. 2. Not shown in FIG. 2 is the subsequent conventional use of the resulting digest stored in storage 45, which is compared by processor 38 to a second expected digest value associated with the incoming message. Only if the two digest values match is the incoming message (a digital document, digital signature or similar information) authenticated.

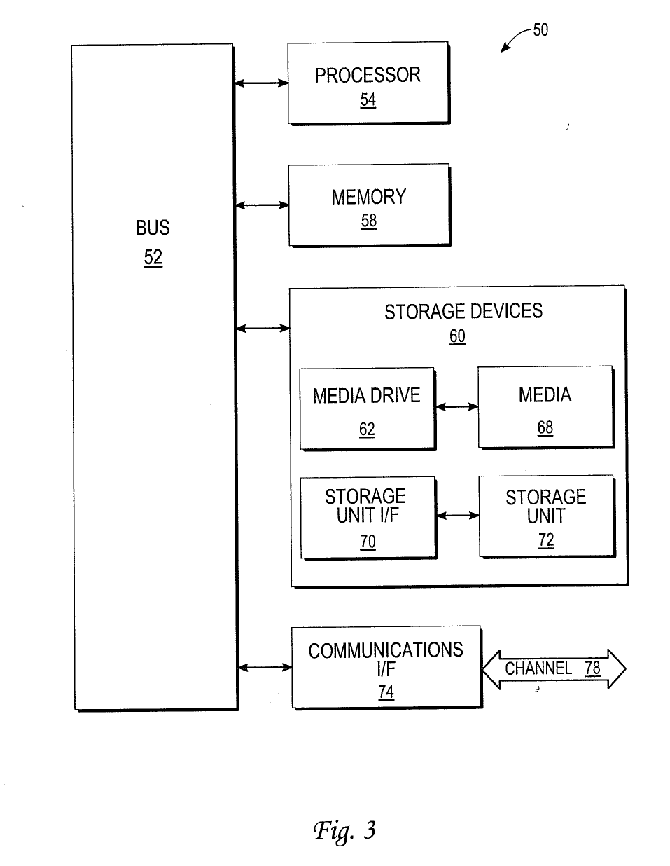

FIG. 3 shows further detail of the FIG. 2 computing device in one embodiment. FIG. 3 illustrates a typical and conventional computing system 50 that may be employed to implement processing functionality in embodiments of the invention and shows additional detail of the FIG. 2 system. Computing systems of this type may be used in a computer server or user (client) computer or other computing device, for example. Those skilled in the relevant art will also recognize how to implement embodiments of the invention using other computer systems or architectures. Computing system 50 may represent, for example, a desktop, laptop or notebook computer, hand-held computing device (personal digital assistant (PDA), cell phone, palmtop, etc.), mainframe, server, client, or any other type of special or general purpose computing device as may be desirable or appropriate for a given application or environment. Computing system 50 can include one or more processors, such as a processor 54 (equivalent to processor 38 in FIG. 2). Processor 54 can be implemented using a general or special purpose processing engine such as, for example, a microprocessor, microcontroller or other control logic. In this example, processor 54 is connected to a bus 52 or other communications medium. Note that in some embodiments the present process is carried out in whole or in part by “hardware” (dedicated circuitry) which is equivalent to the above described software embodiments.

Computing system 50 can also include a main memory 58 (equivalent to memories 36, 40, 41, 43, 45 in FIG. 2), such as random access memory (RAM) or other dynamic memory, for storing information and instructions to be executed by processor 38. Main memory 58 also may be used for storing temporary variables or other intermediate information during execution of instructions to be executed by processor 54. Computing system 50 may likewise include a read only memory (ROM) or other static storage device coupled to bus 52 for storing static information and instructions for processor 54.

Computing system 50 may also include information storage system 60, which may include, for example, a media drive 62 and a removable storage interface 70. The media drive 62 may include a drive or other mechanism to support fixed or removable storage media, such as flash memory, a hard disk drive, a floppy disk drive, a magnetic tape drive, an optical disk drive, a compact disk (CD) or digital versatile disk (DVD) drive (R or RW), or other removable or fixed media drive. Storage media 68 may include, for example, a hard disk, floppy disk, magnetic tape, optical disk, CD or DVD, or other fixed or removable medium that is read by and written to by media drive 62. As these examples illustrate, the storage media 68 may include a computer-readable storage medium having stored therein particular computer software or data.

In alternative embodiments, information storage system 60 may include other similar components for allowing computer programs or other instructions or data to be loaded into computing system 50. Such components may include, for example, a removable storage unit 72 and an interface 70, such as a program cartridge and cartridge interface, a removable memory (for example, a flash memory or other removable memory module) and memory slot, and other removable storage units 72 and interfaces 70 that allow software and data to be transferred from the removable storage unit 68 to computing system 50.

Computing system 50 can also include a communications interface 74 (equivalent to port 32 in FIG. 2). Communications interface 74 can be used to allow software and data to be transferred between computing system 50 and external devices. Examples of communications interface 74 can include a modem, a network interface (such as an Ethernet or other network interface card (NIC)), a communications port (such as for example, a USB port), a PCMCIA slot and card, etc. Software and data transferred via communications interface 74 are in the form of signals which can be electronic, electromagnetic, optical or other signals capable of being received by communications interface 74. These signals are provided to communications interface 74 via a channel 78. This channel 78 may carry signals and may be implemented using a wireless medium, wire or cable, fiber optics, or other communications medium. Some examples of a channel include a phone line, a cellular phone link, an RF link, a network interface, a local or wide area network, and other communications channels.

In this disclosure, the terms “computer program product,” “computer-readable medium” and the like may be used generally to refer to media such as, for example, memory 58, storage device 68, or storage unit 72. These and other forms of computer-readable media may store one or more instructions for use by processor 54, to cause the processor to perform specified operations. Such instructions, generally referred to as “computer program code” (which may be grouped in the form of computer programs or other groupings), when executed, enable the computing system 60 to perform functions of embodiments of the invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 50 using, for example, removable storage drive 72 or communications interface 74. The control logic (in this example, software instructions or computer program code), when executed by the processor 54, causes the processor 54 to perform the functions of embodiments of the invention as described herein.

This disclosure is illustrative and not limiting. Further modifications will be apparent to these skilled in the art in light of this disclosure and are intended to fall within the scope of the appended claims.

We claim:

1. A sponge function method performed by a computing apparatus and comprising the acts of:
(a) receiving a message at an input port;
(b) storing the received message as an array having a plurality of entries in a first computer readable storage medium coupled to the input port;
(c) a processor coupled to the first computer readable storage and modifying the array, according to a cube puzzle algorithm stored in a second computer readable medium coupled to the processor,
(d) the processor updating the array stored in the first computer readable storage according to act (c);
(e) extracting from the updated array resulting from act (d) a digest value of the message; and
(f) the processor storing the digest value in a third computer readable storage medium coupled to the processor.

2. The method of claim 1, wherein act (c) includes modeling a three dimensional puzzle having a plurality of sub-elements which rotate in predetermined groups.

3. The method of claim 2, wherein the modeling includes modeling a cube, each face of the cube defining n*n sub-elements, n being at least 3, each sub-element being associated with one entry of the array.

4. The method of claim 1, wherein (b) further includes partitioning the message into a plurality of blocks.

5. The method of claim 2, wherein the modeling includes defining the rotation by axis, column, and number of rotations.

6. The method of claim 2, wherein the modeling includes providing at least one blank rotation.

7. The method of claim 1, further comprising the acts of:
receiving a digest value associated with the message at the processor;
comparing the received digest value to the stored digest value of (g); and
authenticating the message if the comparison indicates a match.

8. The method of claim 1, wherein the message is one of a digital signature or document, a digital message, a secret key or an identifier.

9. The method of claim 1, further comprising the acts of:
providing a security parameter; and
repeating (a) to (d) a number of times equal to the security parameter.

10. The method of claim 1, wherein each entry in the array is one bit of data, one byte of data, one 16-bit word, one 32-bit word, one 64-bit word, or one 128-bit word.

11. The method of claim 1, wherein the cube puzzle algorithm includes applying the message to a pseudo random number generator as a seed, and using a resulting value in the cube puzzle algorithm.

12. The method of claim 11, wherein in (e) a length of the digest value is variable.

13. The method of claim 1, wherein the cube puzzle algorithm includes applying a non-physical rotation including an exclusive OR rotation, a non-linear rotation, a complex rotation, or a polynomial based rotation, or a rotation wherein the cube turns on itself around one of its axes.

14. A computer readable medium storing computer code instructions for executing the method of claim 1 on the computing apparatus.

15. An apparatus for computing a sponge function, comprising:
(a) an input port for receiving a message;
(b) a first computer readable storage medium coupled to the input port for storing the received message as an array having plurality of entries; and
(c) a processor coupled to the first storage medium and which modifies entries of the array according to a cube puzzle algorithm;
(d) wherein the processor updates the array according to (c);
(e) wherein the processor extracts from the updated array a digest value of the message; and
(f) wherein the processor stores the digest value in a second computer readable storage medium coupled to the processor.

16. The apparatus of claim 15, wherein (c) includes modeling a three dimensional puzzle having a plurality of sub-elements which rotate in predetermined groups.

17. The apparatus of claim 16, wherein the modeling includes modeling a cube, each face of the cube defining n * n sub-elements, n being at least 3, each sub-element being associated with one entry of the array.

18. The apparatus of claim 15, wherein (b) further includes partitioning the message into a plurality of blocks.

19. The apparatus of claim 15, wherein the modeling includes defining the rotation by axis, column, and number of rotations.

20. The apparatus of claim 19, wherein the modeling includes providing at least one blank rotation.

21. The apparatus of claim 15, further comprising:
receiving at the processor from the port a digest value associated with the message;
comparing at the processor the received digest value to the stored digest value of (g); and
authenticating the message if the comparison indicates a match.

22. The apparatus of claim 15, wherein the message is one of a digital signature or document, a digital message, a secret key or an identifier.

23. The apparatus of claim 15, further comprising:
providing a security parameter; and
repeating (c) and (d) a number of times equal to the security parameter.

24. The apparatus of claim 15, wherein each value in the array is one bit of data, one byte of data, one 16-bit word, one 32-bit word, one 64-bit word, or one 128-bit word.

25. The apparatus of claim 15, wherein the cube puzzle algorithm includes applying the message to a pseudo random number generator as a seed, and using a resulting value in the cube puzzle algorithm.

26. The apparatus of claim 15, wherein a length of the digest value is variable.

27. The apparatus of claim 16, wherein the cube puzzle algorithm includes applying a non-physical rotation including an exclusive OR rotation, a non-linear rotation, a complex rotation, or a polynomial based rotation, or a rotation wherein the cube turns on itself around one of its axes.
